(19) United States
(12) Patent Application Publication
(10) Pub. No.: US 2024/0275258 A1
(43) Pub. Date: Aug. 15, 2024

(54) POWER CONTROL METHOD AND APPARATUS, POWER SUPPLY SYSTEM, AND ENERGY STORAGE POWER SUPPLY

(71) Applicant: Ninebot New Energy Technology (Beijing) Co., Ltd., Beijing (CN)

(72) Inventors: Jin WANG, Beijing (CN); Shouquan WANG, Beijing (CN)

(21) Appl. No.: 18/443,151

(22) Filed: Feb. 15, 2024

(30) Foreign Application Priority Data
Feb. 15, 2023 (CN) 202310159109.9

(51) Int. Cl. H02M 1/00; H02J 7/00

(52) U.S. Cl. CPC H02M 1/0003; H02J 7/00304; H02J 7/0063; H02M 1/0083; H02J 2207/20

(57) ABSTRACT

The present disclosure provides a power control method and apparatus, a power supply system, and an energy storage power supply. The method provided in the present disclosure mainly includes: determining whether there is an overload device among all load devices of a power supply module, where output voltage of the power supply module is adjustable within an allowable voltage range; if it is determined that there is the overload device, acquiring first target output voltage of the power supply module, where the first target output voltage is within the allowable voltage range and is lower than and close to minimum working voltage of all non-working overload devices; regulating the output voltage of the power supply module to the first target output voltage. When power supply equipment is overloaded, this method uses a voltage regulation method to control an overloaded power supply output to its maximum output power.

### CROSS-REFERENCE TO RELATED APPLICATION

This application claims priority to Chinese Patent Application No. 202310159109.9, filed on Feb. 15, 2023, which is hereby incorporated by reference in its entirety.

### TECHNICAL FIELD

The present application relates to the field of power equipment and, in particular, to a power control method and apparatus, a power supply system, and an energy storage supply.

### BACKGROUND

In a power system, power supply equipment (such as inverters, DC to DC conversion modules) are commonly used power equipment, which can carry out current or voltage conversion. For example, the inverter in the power supply equipment can convert a DC power of an energy storage power supply into an AC power that can be used by user devices. The power supply equipment can supply power to multiple load devices simultaneously, but when a total power required by all of the load devices exceeds a power that the power supply equipment can provide, the power supply equipment will be overloaded, then an overcurrent protection will be generated at this time, causing all of the load devices of the power supply equipment to be unable to work. Therefore, how to perform setup and reasonably solve the overload of the power supply equipment is a problem that needs to be solved currently.

### SUMMARY

The present disclosure provides a power control method and apparatus, a power supply system, and an energy storage supply, in order to solve problems in related technologies and improve performance of load device when power supply equipment being overloaded.

In a first aspect, an embodiment of the present disclosure proposes a power control method, where the method includes: determining whether there is an overload device among all load devices of a power supply module, where output voltage of the power supply module is adjustable within an allowable voltage range; if it is determined that there is the overload device, acquiring first target output voltage of the power supply module, where the first target output voltage is within the allowable voltage range and is lower than and close to minimum working voltage of all non-working overload devices; regulating the output voltage of the power supply module to the first target output voltage.

In a second aspect, an embodiment of the present disclosure proposes a power control apparatus, where the apparatus includes: a first determining unit, configured to determine whether there is an overload device among all load devices of a power supply module, where output voltage of the power supply module is adjustable within an allowable voltage range; a first acquiring unit, configured to acquire first target output voltage of the power supply module if it is determined that there is the overload device, where the first target output voltage is within the allowable voltage range and is lower than and close to minimum working voltage of all non-working overload devices; a first regulating unit, configured to regulate the output voltage of the power supply module to the first target output voltage.

In a third aspect, an embodiment of the present disclosure proposes a power supply system, including: a power supply module, configured to regulate input power; a power output interface, including a main access port and multiple connection interfaces, where the main access port is connected to the power output port of the power supply module, and the connection interfaces are configured to connect to load devices; a voltage regulating module, configured to regulate output voltage of the power supply module; a collecting module, connected to the main access port of the power output interface, and configured to collect a total output electrical energy parameter of the power supply module; a control module, configured to regulate the output voltage of the power supply module according to the total output electrical energy parameter and with use of the power control method according to the embodiment in the first aspect of the present disclosure, to perform power regulation on the power supply module.

In a fourth aspect, an embodiment of the present disclosure proposes an energy storage power supply, including: the power supply system according to the embodiment in the third aspect of the present disclosure; and at least one battery pack, where the battery pack is used to provide power to the power supply system.

The power control method, apparatus, power supply system, and energy storage power supply provided in the present disclosure, including: determining whether there is an overload device among all load devices of a power supply module, where output voltage of the power supply module is adjustable within an allowable voltage range; if it is determined that there is the overload device, acquiring first target output voltage of the power supply module, where the first target output voltage is within the allowable voltage range and is lower than and close to minimum working voltage of all non-working overload devices; regulating the output voltage of the power supply module to the first target output voltage. When power supply equipment is overloaded, output of the overloaded power supply equipment is controlled to maximum output power of the power supply module as much as possible by regulating the output voltage of the power supply module to lowest working voltage of the overload device, thereby improving the performance of non-overload devices. Compared with existing methods, the power supply of the power supply equipment can be more fully utilized, thereby better meeting power requirements of electrical devices.

It should be understood that general descriptions above and detailed description in the following text are only illustrative and explanatory, and cannot limit the present disclosure.

### BRIEF DESCRIPTION OF DRAWINGS

Accompanying drawings here are incorporated into the specification and form a part of this specification, showing embodiments in compliance with the present disclosure and used together with the specification to explain principles of the present disclosure, and do not constitute any improper limitation of the present disclosure.

FIG. 1 is a flowchart of a power control method provided by an embodiment of the present disclosure.

FIG. 2 is a flowchart of a power control method provided by an embodiment of the present disclosure.

FIG. 3 is a flowchart of a power control method provided by an embodiment of the present disclosure.

FIG. 4 is a flowchart of a power control method provided by an embodiment of the present disclosure.

FIG. 5 is a flowchart of a power control method provided by an embodiment of the present disclosure.

FIG. 6 is a flowchart of a power control method provided by an embodiment of the present disclosure.

FIG. 7 is a flowchart of a power control method provided by an embodiment of the present disclosure.

FIG. 8 is a flowchart of a power control method provided by an embodiment of the present disclosure.

FIG. 9 is a schematic diagram of a hardware block diagram scheme of a device provided by an embodiment of the present disclosure.

FIG. 10 is a schematic diagram of a hardware block diagram scheme of a device provided by an embodiment of the present disclosure.

FIG. 11 is a schematic diagram of a hardware block diagram scheme of a device provided by an embodiment of the present disclosure.

FIG. 12 is a schematic diagram of an overall process for regulating power provided by an embodiment of the present disclosure.

FIG. 13 is a composition block diagram of a power control apparatus provided by an embodiment of the present disclosure.

FIG. 14 is a composition block diagram of a power control apparatus provided by an embodiment of the present disclosure.

FIG. 15 is a composition block diagram of a power control apparatus provided by an embodiment of the present disclosure.

FIG. 16 is a composition block diagram of a power control apparatus provided by an embodiment of the present disclosure.

FIG. 17 is a composition block diagram of a power control apparatus provided by an embodiment of the present disclosure.

FIG. 18 is a composition block diagram of a power control apparatus provided by an embodiment of the present disclosure.

FIG. 19 is a structural schematic diagram of an electronic device provided by an embodiment of the present disclosure.

### DESCRIPTION OF EMBODIMENTS

The following describes in detail embodiments of the present disclosure, and examples of the embodiments are shown in accompanying drawings, throughout which the identical or similar reference signs represent identical or similar elements or elements having identical or similar functions. The embodiments described below with reference to the accompanying drawings are exemplary and intended to explain the present disclosure, but cannot be understood as limiting the present disclosure.

In a power system, power supply equipment is a kind of commonly used power supply equipment, for example, it can convert direct current of an energy storage power supply into alternating current that can be used by user equipment. But when encountering an overload state, that is, when power of electrical devices exceeds maximum output power of the power supply equipment, a problem of short-circuit protection of the power supply equipment will be generated, causing the electrical device to be unable to work. Therefore, how to set up appropriate power control methods is a problem that currently needs to be solved.

When encountering an overload problem, previous solutions were to directly turn off the electrical device and restrict user device usages. However, this method can cause many user equipment to be unable to work, causing inconvenience to users and seriously affecting user experience. Another solution is to directly limit the user equipment to operate at its lowest working voltage, but this can lead to poor performance of the load device, reducing the performance of the user equipment and usage experience of the user. Moreover, the inventors of the present disclosure have found that this solution is prone to a power waste.

In order to solve the problems in related technologies, when the power supply equipment is overloaded, this method can regulate output voltage of a power supply module to the minimum working voltage of an overload device, to control an output of the overloaded power supply equipment to its maximum output power, thereby improving performance of non-overload devices. Compared with previous methods of turning off or limiting the output of power supply equipment after overload, this method can more effectively utilize power supply performance of the power supply equipment, thereby better meeting power requirements of the electrical device.

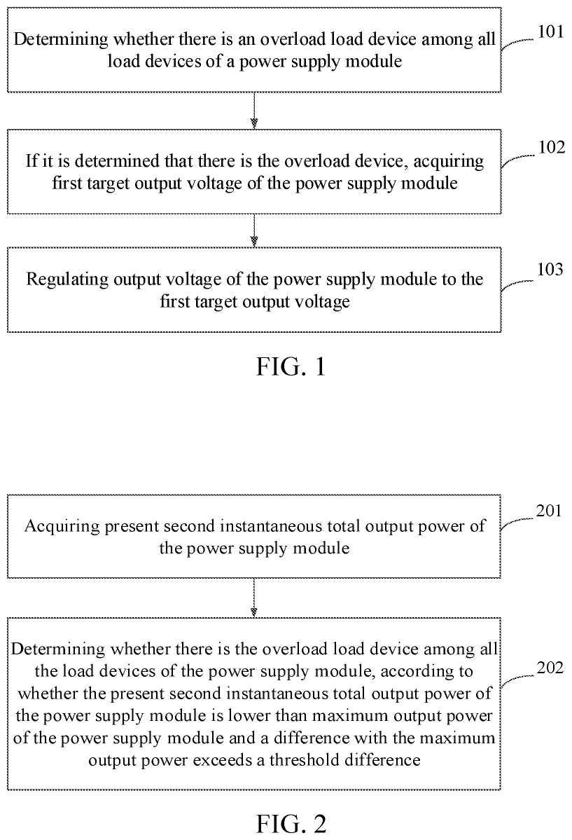

FIG. 1 is a flowchart of a power control method provided by an embodiment of the present disclosure. As shown in FIG. 1, steps 101-103 are included.

Step 101, determining whether there is an overload device among all load devices in a power supply module.

It should be noted in the embodiment of the present disclosure that, output voltage of the power supply module is adjustable within an allowable voltage range, and specific types of the power supply module are not limited by the present disclosure. Since the power supply equipment with a power supply module has a maximum power limit during power supply, the overload of the power supply equipment refers to an abnormal working state where the output of the power supply equipment exceeds its maximum power limit during an actual usage. For example, taking an invertor in the power supply equipment as an example, the maximum output power of an inverter A is 1000 W. At time t, the inverter is connected to three load devices, which are load device I with the power of 300 W, load device II with the power of 500 W, and load device III with the power of 1200 W. By summing up the power of the three load devices, it can be calculated that actual total output power of the inverter at time t is 2000 W, which exceeds the maximum output power of 1000 W of the inverter. Therefore, the inverter is in an overload state at time t, that is, the power supply equipment is in the overload state at time t. The inverter can output 2000 W in a short period of time, but it will soon cause an overcurrent protection action, and the inverter will not be able to work normally, causing all the load devices to be unable to work. In addition, the total power required for these three load devices is 2000 W, which exceeds the maximum output power 1000 W of the inverter, thus these three load devices cannot work simultaneously. If the load device III stops working, then the load devices I and II can work, and the load device III would be called as the overload device.

In addition, it should be noted that in the embodiment of the present disclosure, explanations are made by using the inverter in the power supply equipment as an example. However, in addition to the inverter, this method can also be applied to other power supply equipment with a certain power, such as a converter, a frequency converter, or a DC-DC module. The specific types of the power supply equipment are not limited by the present disclosure.

When a load device stops working due to overloading, it can be visually judged from outside whether the load device has stopped working. However, the power supply module (such as the inverter in the energy storage power supply) is not aware of the situation of the load device. If the user is enabled to set up, which will make operations complicated. Therefore, in some embodiments, in the above step 101, an implementation about the determining whether there is the overload device among all the load devices of the power supply module includes: determining whether there is the overload device among all the load devices of the power supply module, by regulating the output voltage of the power supply module within the allowable voltage range and comparing instantaneous total output power of the power supply module before regulating the output voltage with instantaneous total output power of the power supply module after regulating the output voltage. The inventors found that minimum working voltage usually varies among different load devices in the power supply module. Working voltage of the load device would change when regulating the output voltage of the power supply module. When the output voltage of the power supply module is low, it will make some load devices unable to start. Based on this, the inventors came up with a solution to determine whether there is the overload device based on this embodiment. Specifically, for example, if the output power of the power supply module is significantly reduced after lowering the output voltage of the power supply module, it can be considered that there is a load that stops working after lowering the output voltage; conversely, if the output power is significantly increased after raising the output voltage, it can be considered that there is a load that restarts working after raising the output voltage. By using this judgment method, the overload device can be determined without knowledge of the load devices connected to the power supply module. Therefore, regulation can be achieved without users' perception, thereby improving user experience.

Step 102, if it is determined that there is the overload device, acquiring first target output voltage of the power supply module.

It should be noted in the embodiment of the present disclosure that, the first target output voltage is within the allowable voltage range, which is lower than and close to minimum working voltage of all non-working overload devices. A specific voltage acquiring method is not limited in the present disclosure.

Step 103, regulating the output voltage of the power supply module to the first target output voltage.

It should be noted in the embodiment of the present disclosure that, different methods can be used to regulate the output voltage of the power supply module, such as a PWM pulse width modulation voltage-regulation or a DAB circuit (dual active bridge converter) regulation, and the like. Specifically, for example, when using the PWM pulse width modulation voltage-regulation, the output voltage of the power supply module can be regulated by regulating a duty cycle. Other specific regulating methods are not limited by the present disclosure.

In summary, the power control method provided by the present disclosure includes: determining whether there is the overload device among all the load devices of the power supply module, where the output voltage of the power supply module is adjustable within the allowable voltage range; if it is determined that there is the overload device, acquiring the first target output voltage of the power supply module, where the first target output voltage is within the allowable voltage range and is lower than and close to the minimum working voltage of all non-working overload devices; regulating the output voltage of the power supply module to the first target output voltage. When the power supply module is overloaded, this method uses a voltage regulating method to control the output of the overloaded power supply equipment to its maximum output power, so that the non-overload devices can fully utilize the output power of the power supply module, thereby improving the performance of the non-overload devices. Compared with previous methods of turning off or limiting the output of the power supply equipment after overload, this method can more effectively utilize power supply performance of the power supply equipment, thereby better meeting power requirements of electrical devices.

Furthermore, when it is discovered that the instantaneous total power actually output by the power supply module exceeds maximum output power of the power supply module, the output voltage can be determined based on the maximum output power, to attempt to regulate the total output power of the power supply module to a maximum. In this case, in some embodiments of the present disclosure, when determining whether there is the overload device among all the load devices of the power supply module in step 101, the implementation is possible through but not limited to the following method, as shown in FIG. 2, steps 201 and 202 are specifically included.

Step 201, acquiring present second instantaneous total output power of the power supply module.

It should be noted in the embodiment of the present disclosure that, the present second instantaneous total output power is the actual power after attempting to regulate the output power of the power supply module to the maximum. A specific acquiring method is not limited in the present disclosure.

Step 202, determining whether there is the overload device among all the load devices of the power supply module, according to whether the present second instantaneous total output power of the power supply module is lower than the maximum output power of the power supply module and a difference with the maximum output power exceeds a threshold difference.

It should be noted in the embodiment of the present disclosure that, the threshold difference is a difference out of threshold range values reflecting that the actual output power of the power supply module is significantly lower than the maximum output power thereof, and a specific value is not limited by the present disclosure. Specifically, in a process of attempting to regulate the output power of the power supply module to the maximum, if there is no load device that stops working, the actual output power of the power supply module can approach the maximum output power of the power supply module. Conversely, if there is a load device that stops working, the actual output power of the power supply module will be significantly lower than the maximum output power of the power supply module. Therefore, based on this, it can be determined whether there is the overload device without knowledge of the load devices.

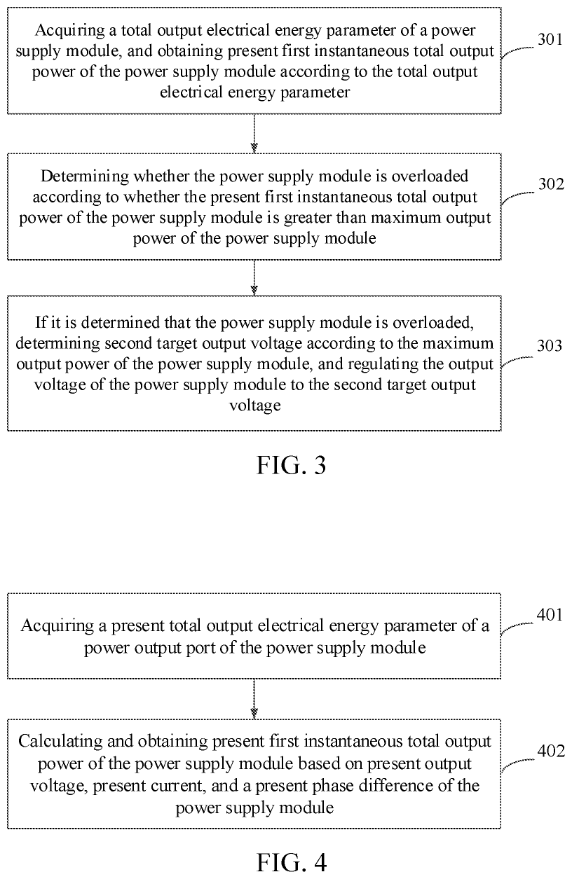

Furthermore, in some embodiments of the present disclosure, before the determining whether is the overload device among all the load devices of the power supply module in step 202, this method further includes a power overload state judgment and a first-time power regulation of the power supply module. A specific regulation can be achieved through but not limited to the following method, as shown in FIG. 3, the following steps are included.

Step 301, acquiring a total output electrical energy parameter of the power supply module, and obtaining present first instantaneous total output power of the power supply module according to the total output electrical energy parameter.

It should be noted in the embodiment of the present disclosure that, the present total output electrical energy parameter may include, but not limited to including present output voltage, present current and a present phase difference, and specific types of the output electrical energy parameter are not limited by the present disclosure. The present first instantaneous total output power of the power supply module is a sum of power output by the power supply module to all the load devices.

Step 302, determining whether the power supply module is overloaded according to whether the present first instantaneous total output power of the power supply module is greater than maximum output power of the power supply module.

It should be noted in the embodiment of the present disclosure that, the present first instantaneous total output power of the power supply equipment refers to real-time total output power of the power supply equipment, which is actual output power of the power supply equipment during operation. The maximum output power of the power supply equipment refers to theoretical maximum output power of the power supply equipment. Specific power values are determined based on actual equipment and are not limited by the present disclosure.

Step 303, if it is determined that the power supply module is overloaded, determining second target output voltage according to the maximum output power of the power supply module, and regulating the output voltage of the power supply module to the second target output voltage.

It should be noted in the embodiment of the present disclosure that, the second target output voltage is voltage at which the actual total output power output by the power supply module to all the load devices does not exceed the maximum output power of the power supply module; if it is determined that the power supply equipment is overloaded, regulate the actual total output power output by the power supply module to all the load devices, that is, regulating the real-time output power of the power supply equipment through a voltage regulation. And if the power supply equipment is not overloaded, there is no need to regulate the power supply equipment. Specific regulation methods and means are not limited by the present disclosure.

By means of the above steps, i.e., step 301 to step 303, before executing the step 101, judging whether the power supply module is overloaded; if it is overloaded, lowering the output voltage to enable the actual output power to not exceed the maximum output power. For example, a regulation to the maximum output power can quickly prevent the power supply module from stopping working due to an overcurrent protection. In this case, it is possible to further determine whether there is the overload device through the above step 101; if yes, proceed with execution of step 102 and the like; if no, the power supply module can operate at present output power. When the power supply module was regulated to its maximum output power previously, the power supply module can operate at full power. Therefore, when the power supply module is overloaded but there is no overload device, the output power of the power supply module also can be fully utilized, thereby ensuring performance of load devices as much as possible.

Furthermore, in some embodiments of the present disclosure, when performing the step 301 of acquiring the total output electrical energy parameter of the power supply module and obtaining the present first instantaneous total output power of the power supply module according to the total output electrical energy parameter, the implementation is possible through, but not limited to the following method, as shown in FIG. 4, the following steps are specifically included.

Step 401, acquiring a present total output electrical energy parameter of a power output port of the power supply module.

It should be noted in the embodiment of the present disclosure that, the present total output electrical energy parameter includes present output voltage, present current, and a present phase difference. A specific parameter acquiring method is not limited by the present disclosure.

Step 402, calculating and obtaining the present first instantaneous total output power of the power supply module based on the present output voltage, the present current, and the present phase difference of the power supply module.

In the embodiment of the present disclosure, after the present output voltage, the present current and the present phase difference of the power supply equipment are obtained, when acquiring the present first instantaneous total output power of the power supply equipment, it can be calculated and obtained through but not limited to Formula 1, the Formula 1 can be expressed as follows:

$$P = UI cos θ \qquad ( Formula 1 )$$

where P is the present first instantaneous total output power of the power supply equipment, U is the present output voltage, I is the present current, cos θ is a power factor, which is determined based on the phase difference obtained from the present voltage and the present current.

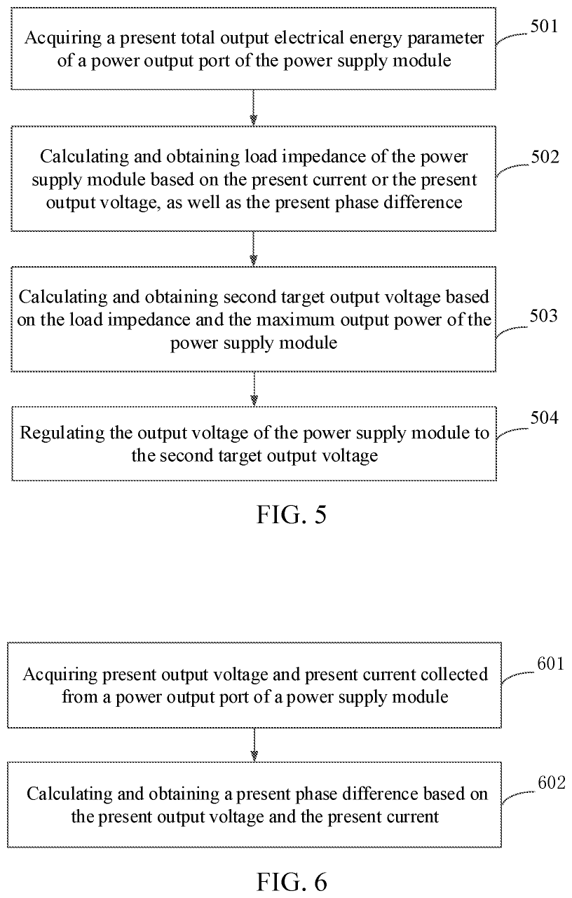

Furthermore, in some embodiments of the present disclosure, when performing the step 303 of determining the second target output voltage according to the maximum output power of the power supply module and regulating the output voltage of the power supply module to the second target output voltage, the implementation is possible through but not limited to the following method, as shown in FIG. 5, the following steps are specifically included.

Step 501, acquiring a present total output electrical energy parameter of a power output port of the power supply module

What needs to be explained here in the present disclosure has been elaborated in the above steps and will not be repeated here. Specific parameter categories are not limited in the present disclosure.

Step 502, calculating and obtaining load impedance of the power supply module based on the present current or the present output voltage, as well as the present phase difference.

It should be noted in the embodiment of the present disclosure that, the load impedance is a sum of impeding effects from respective load devices for AC power, which needs to be calculated based on the actual type of the load devices and can be obtained through but not limited to Formula 2, where the Formula 2 can be expressed as follows:

$$R = \frac{P}{{I}^{2} cos θ} \qquad ( Formula 2 )$$

where R is the load impedance, P is the present first instantaneous total output power of the power supply equipment, I is the present current, cos θ is the power factor, which is determined based on the phase difference obtained from the present voltage and the present current.

Step 503, calculating and obtaining the second target output voltage based on the load impedance and the maximum output power of the power supply module.

It should be noted in the embodiment of the present disclosure that, the second target output voltage is the voltage at which the power supply equipment outputs the maximum output power. After the load impedance and the maximum output power of the power supply equipment are obtained, when obtaining the second target output voltage, it can be calculated and obtained through but not limited to Formula 3, where the Formula 3 can be expressed as follows:

$$U = \frac{{P}_{max}}{R} \qquad ( Formula 3 )$$

where U is regulated voltage, R is the load impedance, and Pₘₐₓ is the maximum output power of the power supply equipment.

Step 504, regulating the output voltage of the power supply module to the second target output voltage.

It should be noted in the embodiment of the present disclosure that, the voltage of the power supply equipment can be regulated using different methods, such as a pulse width modulation voltage-regulation, a phase shift voltage-regulation, or other voltage regulation method such as boost circuits. The specific regulating methods are not limited by the present disclosure.

Furthermore, in some embodiments of the present disclosure, before the present first instantaneous total output power and the second target output voltage of the power supply module are calculated, when acquiring the present total output electrical energy parameter of the power output port of the power supply module, the implementation is possible through but not limited to the following method, as shown in FIG. 6, the following steps are specifically included.

Step 601, acquiring the present output voltage and the present current collected from the power output port of the power supply module.

It should be noted in the embodiment of the present disclosure that, the present output voltage and the present current can be obtained through but not limited to being collected by a sensor at an output port of the power supply equipment, for example, obtained by a sensor through collection on an AC (alternating current) output port of an inverter. A specific collecting method is not limited by the present disclosure.

Step 602, calculating and obtaining a present phase difference based on the present output voltage and the present current.

It should be noted in the embodiment of the present disclosure that, the present phase difference is calculated and obtained by the present voltage and the present current, and function of which is to determine a load type, where the type may include but is not limited to resistive loads and inductive loads. In subsequent power calculations, different power factors will be introduced based on different load types. A specific calculating method is not limited by the present disclosure.

Furthermore, in some embodiments of the present disclosure, when performing the step 102 of acquiring the first target output voltage of the power supply module, the implementation is possible through but not limited to the following method: continuously regulating the output voltage of the power supply module within the allowable voltage range, and determining whether to turn up or turn down the output voltage of the power supply module in a next regulation according to whether there is a step change in instantaneous total output power of the power supply module after each regulation relative to instantaneous total output power of the power supply module prior to the regulation, until a difference between a prior-to-regulation output voltage and an post-regulation output voltage is within a threshold voltage difference range or the instantaneous total output power of the power supply module reaches or approaches the maximum output power of the power supply module, and taking a smaller one between the prior-to-regulation output voltage and the post-regulation output voltage as the first target output voltage. The step change can reflect a significant change in the output power of the power supply module under both working and non-working status of the overload device.

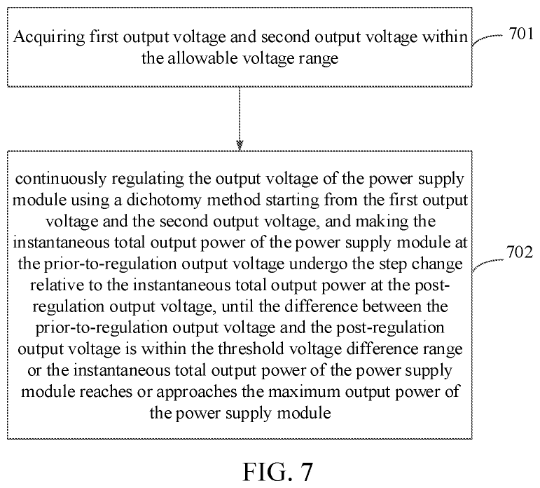

Specifically, in some embodiments of the present disclosure, when continuously regulating the output voltage of the power supply module, the implementation is possible through but not limited to the following method, as shown in FIG. 7, the following steps are specifically included.

Step 701, acquiring first output voltage and second output voltage within the allowable voltage range.

It should be noted in the embodiment of the present disclosure that, the first output voltage is the second target output voltage obtained in the step 303, and the second output voltage is a lower limit of the allowable voltage range. In addition, when outputting the first output voltage relative to outputting the second output voltage, the instantaneous total output power of the power supply module undergoes the step change, a difference between the first output voltage and the second output voltage is greater than a threshold voltage difference range. And a specific threshold voltage difference range can be defined independently, which is not limited by the present disclosure.

Step 702, continuously regulating the output voltage of the power supply module using a dichotomy method starting from the first output voltage and the second output voltage, and making the instantaneous total output power of the power supply module at the prior-to-regulation output voltage undergo the step change relative to the instantaneous total output power at the post-regulation output voltage, until the difference between the prior-to-regulation output voltage and the post-regulation output voltage is within the threshold voltage difference range or the instantaneous total output power of the power supply module reaches or approaches the maximum output power of the power supply module. In this step, the dichotomy method can be used to quickly find the output voltage of the power supply module near lowest working voltage of non-overload devices. In other embodiments, the output voltage of the power supply module can be continuously regulated through other means.

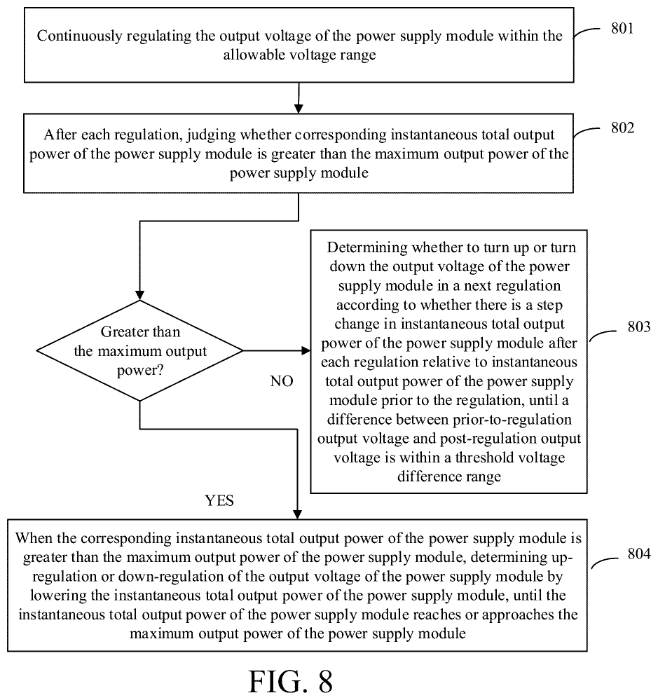

Specifically, in some embodiments of the present disclosure, each time when judging whether to continue regulating the power, the implementation is possible through but not limited to the following method, as shown in FIG. 8, the following steps are specifically included.

Step 801, continuously regulating the output voltage of the power supply module within the allowable voltage range.

What needs to be explained in the present disclosure has been elaborated in the above steps and will not be repeated here. The specific regulating method is not limited in the present disclosure.

Step 802, after each regulation, judging whether corresponding instantaneous total output power of the power supply module is greater than the maximum output power of the power supply module; if the corresponding instantaneous total output power of the power supply module is not greater than the maximum output power of the power supply module, executing step 803; if the corresponding instantaneous total output power of the power supply module is greater than the maximum output power of the power supply module, executing step 804.

What needs to be explained in the present disclosure has been elaborated in the above steps and will not be repeated here. A specific judging method is not limited in the present disclosure.

Step 803, determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range.

Step 804, when the corresponding instantaneous total output power of the power supply module is greater than the maximum output power of the power supply module, determining up-regulation or down-regulation of the output voltage of the power supply module by lowering the instantaneous total output power of the power supply module, until the instantaneous total output power of the power supply module reaches or approaches the maximum output power of the power supply module.

In summary, when the power supply equipment is overloaded, this method controls the output of the overloaded power supply equipment to its maximum output power by means of regulating the voltage. Compared with previous methods of turning off or limiting the output of the power supply equipment after overload, this method can avoid a power waste of the power supply module, more effectively utilize power supply performance of the power supply equipment, and better meet power requirements of electrical devices.

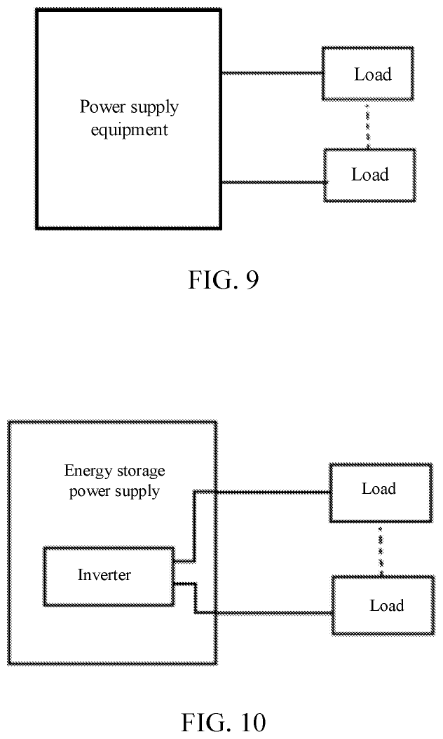

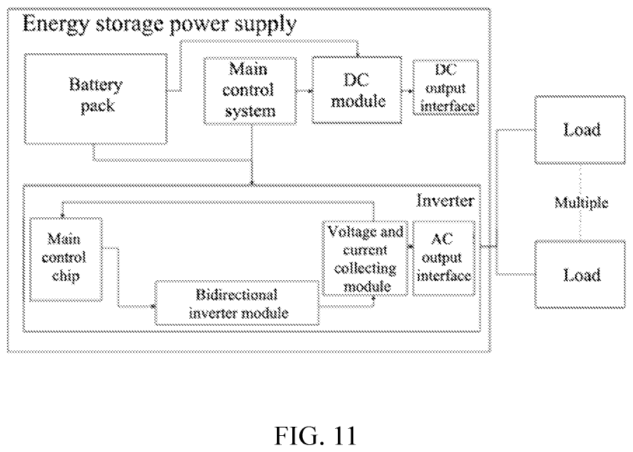

The present disclosure is mainly based on a hardware block diagram scheme of the above device, as shown in FIGS. 9 to 11. Taking an inverter in a power supply module as an example, a power supply system includes:

a power supply module, configured to regulate input power;

a power output interface, including a main access port and multiple connection interfaces, where the main access port is connected to the power output port of the power supply module, and the connection interfaces are configured to connect to load devices;

a voltage regulating module, configured to regulate output voltage of the power supply module;

a collecting module, connected to the main access port of the power output interface, and configured to collect a total output electrical energy parameter of the power supply module;

a control module, configured to regulate the output voltage of the power supply module according to the total output electrical energy parameter and with use of the power control method according to the present disclosure, to perform power regulation on the power supply module.

Furthermore, the power supply module can be a module that can perform various power regulations, such as a power conversion between DC and AC, or a boost or buck power conversion between DC and DC. For example, in some embodiments of the present disclosure, the power supply module may be an inverter module or a DC to DC module.

The output voltage of existing power supply modules (such as inverter modules) is often fixed, that is, the voltage is not adjustable. In the power supply system of this embodiment, the voltage regulating module is set up to regulate the output voltage of the power supply module. A specific allowable voltage range for regulation can be determined by a specific power supply system. In addition, the control module can judge the status of the power supply module according to the total output electrical energy parameter, for example, whether it is overloaded, whether there is an overload device, and the like, and a judging method in the specific embodiment is described in the step 301 and the like. The control module can be used to execute the power control method described in the various embodiments in the present disclosure, and specific implementations can be found in the above embodiments, which will not be elaborated here.

In some specific embodiments of the present disclosure, the overload status at the power output port of the power supply module can be judged mainly by the total instantaneous output power. Through a certain power allocation algorithm, a sum of power for all output ports of the device is equal to the maximum output power of the power supply equipment, maximizing the performance of the power supply equipment and providing users with best user experience.

The power regulating method of the present disclosure starts the following process when discovering that there is a load exceeding the maximum output power supported by the inverter. For example, when the output port of the inverter is connected to multiple load devices simultaneously, where one load (with the highest power, assuming it is a first electrical device) has a power of 2300 W, and the maximum output power of the inverter is 2200 W, then the inverter definitely cannot meet the power requirement of the first electrical device, that is, it cannot work normally. If the first electrical device is not allowed to operate, and the scheme of the present disclosure is not adopted (or other load devices are operated at the lowest supportable power), the total power output by the inverter to other load devices may be much lower than the maximum output power 2200 W of the inverter. In this way, on the one hand, other load devices may underperform due to working at low power; and on the other hand, there is still surplus power that the inverter can output, that is, the power waste. In order to overcome the above problems, and ensure that other load devices fully utilize the maximum output power 2200 W of the inverter, the following method can be adopted. The method includes the following steps.

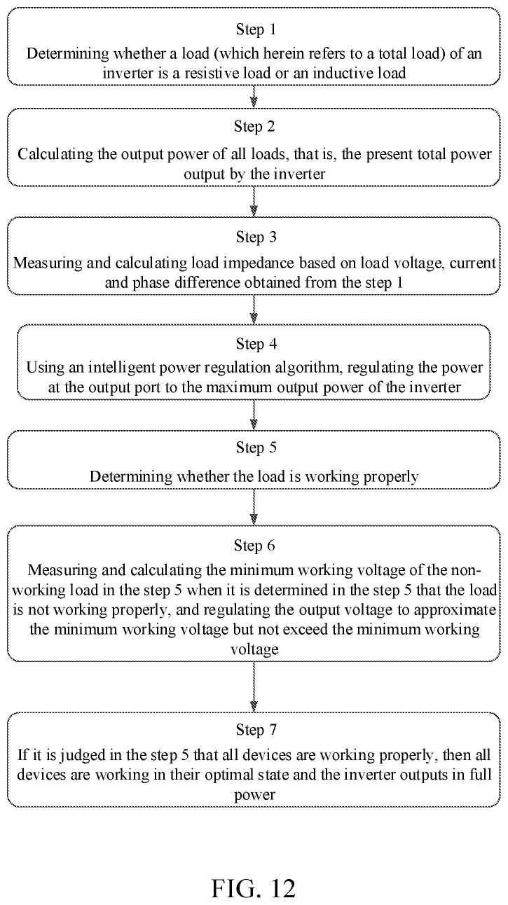

An overall process for regulating power is shown in FIG. 12, including the following steps.

1. Determining whether the load of the inverter (which herein refers to the total load) is a resistive load or an inductive load.

In the embodiment of the present disclosure, when determining whether the load is the resistive load or the inductive load, the implementation is possible but not limited to calculating and obtaining the phase difference based on the voltage and the current collected by the sensor, and judging the load type based on the calculated phase difference of the loads.

2. Calculating the output power of all the loads, that is, the present total power output by the inverter.

In the embodiment of the present disclosure, when calculating the output power of all the loads, it is necessary to firstly obtain the voltage value, the current value and the phase difference required for calculation. This can be implemented by but not limited to using a sensor to collect the voltage and current at an AC output port of an inverter, and then using the collected voltage and current to calculate the phase difference, thereby further calculating the total power output of the inverter.

3. Measuring and calculating load impedance based on load voltage, current, and phase difference obtained from the step 1.

In the embodiment of the present disclosure, when obtaining the load impedance, the calculation of the load impedance can be carried out by but not limited to utilizing the obtained load voltage, current, and phase difference.

4. Using an intelligent power regulation algorithm, regulating the power at the output port to the maximum output power of the inverter.

In the embodiment of the present disclosure, when performing the power regulation, it is necessary to determine whether present total load power exceeds the maximum output power of the inverter firstly; if it exceeds, regulating the power at the output port to the maximum output power of the inverter. When carrying out the regulation, the implementation is possible by but not limited to, calculating the output voltage based on the maximum output power and the load impedance of the inverter, and then regulating the output voltage to a calculated output voltage value through a control voltage-regulation system in a main control chip of the inverter, thereby performing the power regulating of the inverter.

5. Determining whether the load is working properly.

In the embodiment of the present disclosure, after performing the intelligent power regulation algorithm, it will be determined again whether the load is working properly. When making a judgment, whether all load devices are working properly can be judged by but not limited to detecting whether the total output power of the load (such as the total load except for the first electrical device that has been disabled) is close to the maximum output power of the inverter.

6. Measuring and calculating the minimum working voltage of the non-working load in the step 5 when it is determined in the step 5 that the load is not working properly, and regulating the output voltage to approximate the minimum working voltage but not exceed the minimum working voltage.

In the embodiment of the present disclosure, the minimum working voltage of the non-working load is a voltage cutoff about whether it is working properly. When obtaining the minimum working voltage of the non-working load, constant attempts are possible through but not limited to, using the dichotomy method, until a reasonable value is reached. The reasonable value refers to the highest working voltage in an optimal output power state of the system. Then the output voltage of the inverter is regulated to not exceed the minimum working voltage, which can maintain the optimal power output of the inverter and prevent the non-working load from working such as the above first electrical device.

After determining the minimum working voltage of the overload device, the output voltage of the inverter is regulated to approximate the minimum working voltage, and the implementation is possible through but not limited to the following steps.

i. Determining whether the present voltage of the inverter is lower than the minimum voltage of the overload device or higher than the minimum working voltage of the overload device.

In the embodiment of the present disclosure, if the overload device is not working, the present voltage is lower than the minimum working voltage of the overload device; if the output of the inverter is overloaded, the present voltage is higher than the minimum working voltage of the overload device. In specific calculations, the following methods can be used, but not limited to: if it is lower than minimum working voltage of the overload device, the output voltage is calculated as: the present voltage+(voltage regulated in the last time-present voltage)/2; if it is higher than the minimum working voltage of the overload device, the output voltage is calculated as: the present voltage-(present voltage−last voltage)/2.

ii. Repeating the above regulating step i until preset conditions are met.

In the embodiment of the present disclosure, the preset conditions can be but are not limited to, the following two conditions: first, regulating to approximate the lowest voltage, which can be performed through but not limited to, judging whether an absolute value of the present voltage minus the voltage regulated last time is lower than 2V; second, the present voltage is lower than the overload voltage. The present voltage obtained lastly is optimal working voltage for remaining non-overload devices, which can ensure that the working load in step 5 is working in an optimal state, and at this time, the inverter is working in the optimal output power state with the maximum output power.

7. If it is judged in the step 5 that all devices are working properly, then all the devices are working in their optimal state and the inverter outputs in full power.

Therefore, this scheme has the following beneficial effects: when in overload, the scheme regulates real-time output power of the power supply equipment based on the maximum output power of the power supply equipment. Since the regulation is performed based on the maximum output power of the power supply equipment, on the one hand, it avoids previous methods of turning off or limiting the output power of the power supply equipment during overload, which can more effectively utilize the output performance of the power supply equipment; on the other hand, it is more in line with the power requirements of the load device, which can better ensure normal operation requirements of the load device.

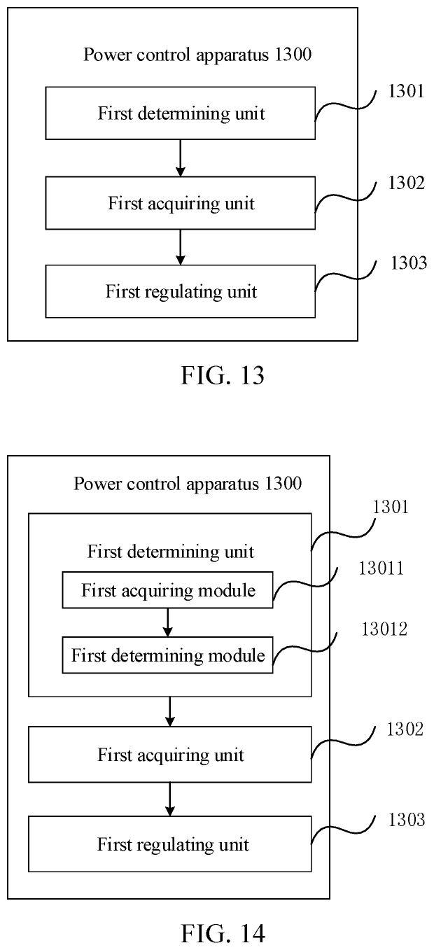

The present disclosure also provides a power control apparatus, for example, the power control apparatus can be a control chip in an inverter, or an apparatus containing the control chip. FIG. 13 is a structural schematic diagram of the power control apparatus 1300 provided by the embodiment of the present disclosure. As shown in FIG. 13, the power control apparatus includes:

a first determining unit 1301, configured to determine whether there is an overload device among all load devices of a power supply module, where output voltage of the power supply module is adjustable within an allowable voltage range;

a first acquiring unit 1302, configured to acquire first target output voltage of the power supply module if it is determined that there is the overload device, where the first target output voltage is within the allowable voltage range, which is lower than and close to minimum working voltage of all non-working overload devices;

a first regulating unit 1303, configured to regulate the output voltage of the power supply module to the first target output voltage.

In some embodiments of the present disclosure, as shown in FIG. 14, the first determining unit 1301 includes:

a first acquiring module 13011, configured to acquire present second instantaneous total output power of the power supply module;

a first determining module 13012, configured to determine whether there is an overload device among all load devices of the power supply module according to whether the present second instantaneous total output power of the power supply module is lower than the maximum output power of the power supply module and the difference with the maximum output power exceeds the threshold difference.

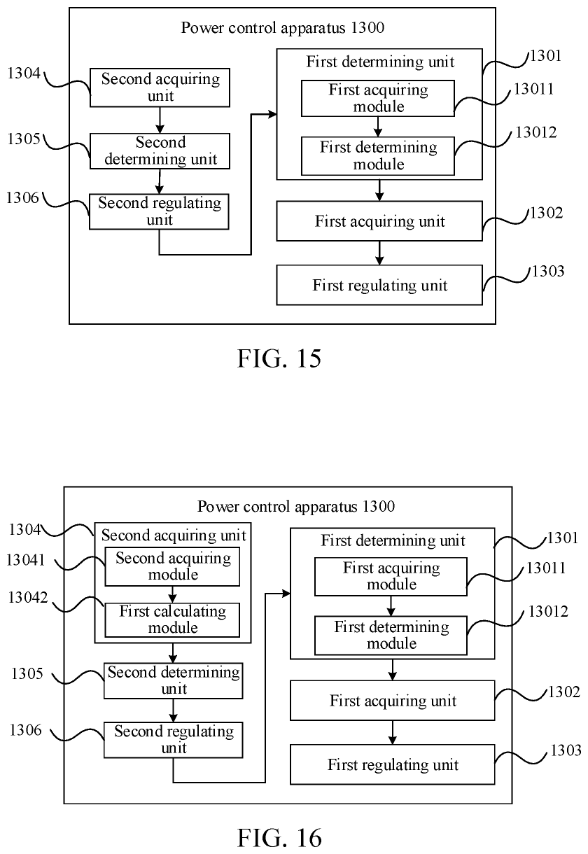

In some embodiments of the present disclosure, as shown in FIG. 15, the first determining unit 1301 further includes:

a second acquiring unit 1304, configured to acquire a total output electrical energy parameter of the power supply module, and obtain present first instantaneous total output power of the power supply module according to the total output electrical energy parameter, where the present first instantaneous total output power of the power supply module is a sum of power output by the power supply module to all the load devices;

a second determining unit 1305, configured to determine whether the power supply module is overloaded according to whether the present first instantaneous total output power of the power supply module is greater than maximum output power of the power supply module;

a second regulating unit 1306, configured to: if it is determined that the power supply module is overloaded, determine second target output voltage according to the maximum output power of the power supply module, and regulate the output voltage of the power supply module to the second target output voltage, where the second target output voltage is voltage at which actual total output power output by the power supply module to all the loaded devices does not exceed the maximum output power of the power supply module.

In some embodiments of the present disclosure, as shown in FIG. 16, the second acquiring unit 1304 includes:

a second acquiring module 13041, configured to acquire a present total output electrical energy parameter of a power output port of the power supply module, where the present total output electrical energy parameter includes present output voltage, present current, and a present phase difference;

a first calculating module 13042, configured to calculate and obtain the present first instantaneous total output power of the power supply module according to the present output voltage, the present current, and the present phase difference of the power supply module.

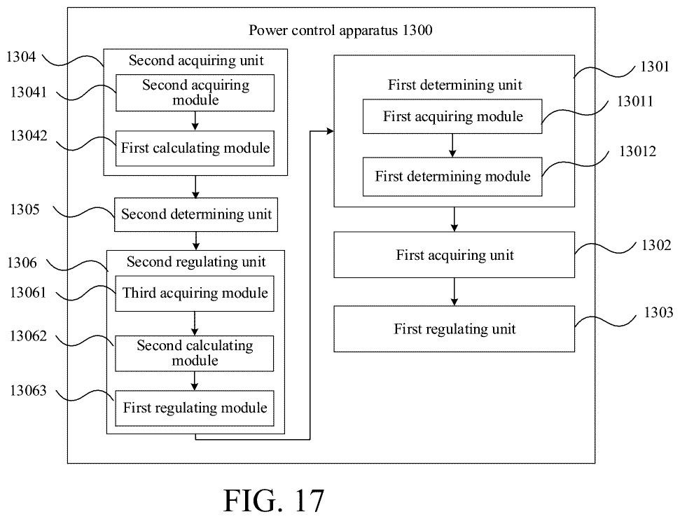

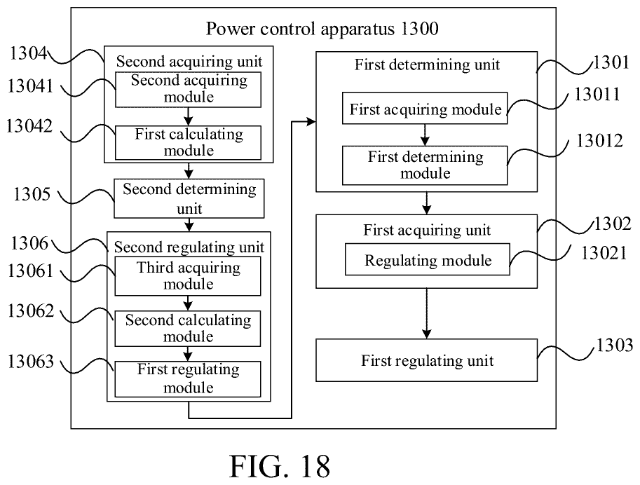

In some embodiments of the present disclosure, as shown in FIG. 17, the second regulating unit 1306 includes:

a third acquiring module 13061, configured to acquire the present total output electrical energy parameter of the power output port of the power supply module, where the present total output electrical energy parameter includes the present output voltage, the present current, and the present phase difference;

a second calculating module 13062, configured to calculate and obtain load impedance of the power supply module according to the present current or the present output voltage, as well as the present phase difference; where the second calculating module 13062 is further configured to calculate and obtain the second target output voltage according to the load impedance and the maximum output power of the power supply module;

a first regulating module 13063, configured to regulate the output voltage of the power supply module to the second target output voltage.

In some embodiments of the present disclosure, the third acquiring module 13061 is further configured to:

acquire the present output voltage and the present current collected from the power output port of the power supply module;

calculate and obtain the present phase difference according to the present output voltage and the present current.

In some embodiments of the present disclosure, as shown in FIG. 18, the first acquiring unit 1302 includes:

a regulating module 13021, configured to continuously regulate the output voltage of the power supply module within the allowable voltage range, and determine whether to turn up or turn down the output voltage of the power supply module in a next regulation according to whether there is a step change in instantaneous total output power of the power supply module after each regulation relative to instantaneous total output power of the power supply module prior to the regulation, until a difference between a prior-to-regulation output voltage and an post-regulation output voltage is within a threshold voltage difference range or the instantaneous total output power of the power supply module reaches or approaches the maximum output power of the power supply module, and take a smaller one between the prior-to-regulation output voltage and the post-regulation output voltage as the first target output voltage.

In some embodiments of the present disclosure, the regulating module 13021 is further configured to:

acquire first output voltage and second output voltage within the allowable voltage range, where when outputting the first output voltage relative to outputting the second output voltage, the instantaneous total output power of the power supply module undergoes the step change, a difference between the first output voltage and the second output voltage is greater than a threshold voltage difference range;

continuously regulate the output voltage of the power supply module using a dichotomy method starting from the first output voltage and the second output voltage, and making the instantaneous total output power of the power supply module at the prior-to-regulation output voltage undergo the step change relative to the instantaneous total output power at the post-regulation output voltage, until the difference between the prior-to-regulation output voltage and the post-regulation output voltage is within the threshold voltage difference range or the instantaneous total output power of the power supply module reaches or approaches the maximum output power.

The first output voltage is the second target output voltage, and the second output voltage is a lower limit of the allowable voltage range.

In some embodiments of the present disclosure, the regulating module 13021 is further configured to:

continuously regulate the output voltage of the power supply module within the allowable voltage range;

after each regulation, judge whether corresponding instantaneous total output power of the power supply module is greater than the maximum output power of the power supply module;

when the corresponding instantaneous total output power of the power supply module is not greater than the maximum output power of the power supply module, determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range;

when the corresponding instantaneous total output power of the power supply module is greater than the maximum output power of the power supply module, determining up-regulation or down-regulation of the output voltage of the power supply module by lowering the instantaneous total output power of the power supply module, until the instantaneous total output power of the power supply module reaches or approaches the maximum output power of the power supply module.

In the embodiment of the present disclosure, when regulating the power, it is first determined whether there is the overload device among all the load devices of the power supply module, where the output voltage of the power supply module is adjustable within the allowable voltage range; if it is determined that there is the overload device, acquiring the first target output voltage of the power supply module, where the first target output voltage is within the allowable voltage range and is lower than and close to the minimum working voltage of all non-working overload devices; regulating the output voltage of the power supply module to the first target output voltage. When the power supply equipment is overloaded, this method controls the output of the overloaded power supply equipment to its maximum output power by means of the voltage regulation. Compared with previous methods of turning off or limiting the output of power supply equipment after overload, this method can more effectively utilize the power supply performance of the power supply equipment, thereby better meeting the power requirements of the electrical device.

In the above embodiments provided by the present application, the methods and apparatus provided by the embodiments of the present application have been introduced. In order to achieve various functions of the methods provided by the above embodiments of the present application, the electronic device may include a hardware structure, a software module, or a combination of hardware structure and software module to achieve the above functions. One of the above functions can be executed in the form of hardware structure, software module, or hardware structure plus software module.

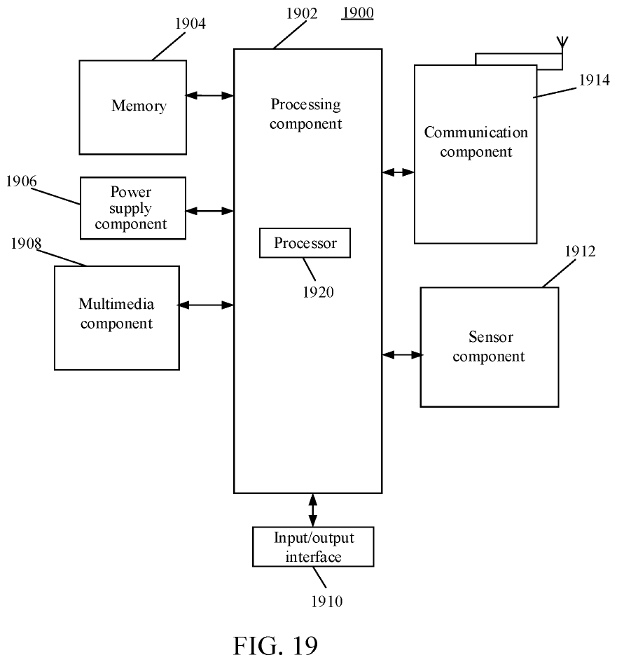

FIG. 19 is a block diagram of an electronic device 1900 for implementing the power control method described above, illustrated according to an exemplary embodiment.

Referring to FIG. 19, the electronic device 1900 may include one or more of the following components: a processing component 1902, a memory 1904, a power supply component 1906, a multimedia component 1908, an input/output (I/O) interface 1910, a sensor component 1910, and a communication component 1914.

The processing component 1902 typically controls overall operations of the electronic device 1900, such as operations associated with displays, data communications, and recording operations. The processing component 1902 may include one or more processors 1920 to execute instructions, so as to complete all or part of steps in the above method. In addition, the processing component 1902 may include one or more modules to facilitate interactions between the processing component 1902 and other components.

The memory 1904 is configured to store various types of data to support operations on the electronic devices 1900. Examples of these data include instructions for any application or method used to operate on the electronic device 1900, contact data, phone book data, messages, images, videos, and the like. The memory 1904 can be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc.

The power supply component 1906 provides power to various components of the electronic device 1900. The power component 1906 may include a power management system, one or more power supplies, and other components associated with generating, managing, and distributing power for the electronic device 1900.

The multimedia component 1908 includes a screen that provides an output interface between the electronic device 1900 and users. In some embodiments, the screen may include a liquid crystal display (LCD) and a touch panel (TP). If the screen includes the touch panel, the screen can be implemented as a touch screen, so as to receive input signals from the user. The touch panel includes one or more touch sensors to sense touches, sliding, and gestures on the touch panel. The touch sensors can not only sense boundaries of touch or sliding actions, but also detect a duration and pressure associated with the touch or sliding operations.

The I/O interface 1912 provides an interface between the processing component 1902 and peripheral interface modules, and the peripheral interface module can be buttons, and the like. These buttons may include but are not limited to: home-page button, start button, and lock button.

The sensor component 1914 includes one or more sensors for providing various aspects of state evaluation for the electronic device 1900. For example, the sensor component 1914 can detect an open/closed state of the electronic device 1900, and a relative positioning of components.

The communication component 1916 is configured to facilitate wired or wireless communications between the electronic device 1900 and other devices. The electronic devices 1900 can access wireless networks based on communication standards, such as WiFi, 2G or 3G, 4G LTE, 5G NR (New Radio), or a combination of them. In an exemplary embodiment, the communication component 1916 receives broadcast signals or broadcast related information from an external broadcast management system via a broadcast channel.

In exemplary embodiments, the electronic device 1900 may be implemented by one or more application specific integrated circuits (ASIC), digital signal processors (DSP), digital signal processing devices (DSPD), programmable logic devices (PLD), field programmable gate array (FPGAs), controllers, microcontrollers, microprocessors, or other electronic components, so as to perform the above methods.

In exemplary embodiments, there is also provided a non-temporary computer-readable storage medium containing instructions, such as the memory 1904 containing the instructions, and the above instructions can be executed by a processor 1920 of the electronic device 1900 to complete the above method. For example, the non-temporary computer-readable storage media can be a ROM, a random access memory (RAM), a CD-ROM, a magnetic tape, a floppy disk, and an optical data storage device.

The embodiment of the present disclosure also proposes a power supply system, including: a power supply module, configured to regulate input power; a power output interface, including a main access port and multiple connection interfaces, where the main access port is connected to the power output port of the power supply module, and the connection interfaces are configured to connect to load devices; a voltage regulating module, configured to regulate output voltage of the power supply module; a collecting module, connected to the main access port of the power supply interface, and configured to collect a total output electrical energy parameter of the power supply module; a control module, configured to regulate the output voltage of the power supply module according to the total output electrical energy parameter and with use of the power control method according to the embodiment in the first aspect of the present disclosure, to perform power regulation on the power supply module.

The embodiment of the present disclosure further proposes an energy storage power supply, including: the power supply system according to the embodiment in the third aspect of the present disclosure; and at least one battery pack, where the battery pack is used to provide power to the power supply system.

It should be noted that, terms “first”, “second” and the like in the specification, claims, and accompanying drawings of the present disclosure are used to distinguish similar objects, and do not necessarily need to be used to describe a specific order or sequence. It should be understood that data used in this way can be interchanged in appropriate cases, so that the embodiments of the present disclosure described here can be implemented in order other than those illustrated or described herein. Implementations described in the following exemplary embodiments do not represent all embodiments consistent with the present disclosure. On the contrary, they are only examples of apparatus and methods consistent with some aspects of the present disclosure as detailed in the attached claims.

In a first aspect, an embodiment of the present disclosure proposes a power control method, where the method includes: determining whether there is an overload device among all load devices of a power supply module, where output voltage of the power supply module is adjustable within an allowable voltage range; if it is determined that there is the overload device, acquiring first target output voltage of the power supply module, where the first target output voltage is within the allowable voltage range and is lower than and close to minimum working voltage of all non-working overload devices; regulating the output voltage of the power supply module to the first target output voltage.

In some embodiments of the present disclosure, the determining whether there is the overload device among all the load devices of the power supply module includes: determining whether there is the overload device among all the load devices of the power supply module, by regulating the output voltage of the power supply module within the allowable voltage range and comparing instantaneous total output power of the power supply module before regulating the output voltage with instantaneous total output power of the power supply module after regulating the output voltage.

In some embodiments of the present disclosure, before the determining whether there is the overload device among all the load devices of the power supply module, the method further includes: acquiring a total output electrical energy parameter of the power supply module, and obtaining present first instantaneous total output power of the power supply module according to the total output electrical energy parameter, where the present first instantaneous total output power of the power supply module is a sum power output by the power supply module to all the load devices; determining whether the power supply module is overloaded according to whether the present first instantaneous total output power of the power supply module is greater than maximum output power of the power supply module; if it is determined that the power supply module is overloaded, determining second target output voltage according to the maximum output power of the power supply module, and regulating the output voltage of the power supply module to the second target output voltage, where the second target output voltage is voltage at which actual total output power output by the power supply module to all the load devices does not exceed the maximum output power of the power supply module.

In some embodiments of the present disclosure, the determining whether there is the overload device among all the load devices of the power supply module includes: acquiring present second instantaneous total output power of the power supply module; and determining whether there is the overload device among all the load devices of the power supply module, according to whether the present second instantaneous total output power of the power supply module is lower than the maximum output power of the power supply module and a difference with the maximum output power exceeds a threshold difference.

In some embodiments of the present disclosure, the acquiring the total output electrical energy parameter of the power supply module, and the obtaining the present first instantaneous total output power of the power supply module according to the total output electrical energy parameter, include: acquiring a present total output electrical energy parameter of a power output port of the power supply module, where the present total output electrical energy parameter includes present output voltage, present current, and a present phase difference; calculating and obtaining the present first instantaneous total output power of the power supply module according to the present output voltage, the present current, and the present phase difference of the power supply module.

In some embodiments of the present disclosure, the determining the second target output voltage according to the maximum output power of the power supply module, and the regulating the output voltage of the power supply module to the second target output voltage include: acquiring the present total output electrical energy parameter of the power output port of the power supply module, where the present total output electrical energy parameter includes the present output voltage, the present current, and the present phase difference; calculating and obtaining load impedance of the power supply module according to the present current or the present output voltage, as well as the present phase difference; calculating and obtaining the second target output voltage according to the load impedance and the maximum output power of the power supply module; and regulating the output voltage of the power supply module to the second target output voltage.

In some embodiments of the present disclosure, the acquiring the present total output electrical energy parameter of the power output port of the power supply module includes: acquiring the present output voltage and the present current collected from the power output port of the power supply module; calculating and obtaining the present phase difference according to the present output voltage and the present current.

In some embodiments of the present disclosure, the acquiring the first target output voltage of the power supply module includes: continuously regulating the output voltage of the power supply module within the allowable voltage range, and determining whether to turn up or turn down the output voltage of the power supply module in a next regulation according to whether there is a step change in instantaneous total output power of the power supply module after each regulation relative to instantaneous total output power of the power supply module prior to the regulation, until a difference between a prior-to-regulation output voltage and an post-regulation output voltage is within a threshold voltage difference range or the instantaneous total output power of the power supply module reaches or approaches the maximum output power of the power supply module, and taking a smaller one between the prior-to-regulation output voltage and the post-regulation output voltage as the first target output voltage.

In some embodiments of the present disclosure, the continuously regulating the output voltage of the power supply module within the allowable voltage range, and the determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range or the instantaneous total output power of the power supply module reaches or approaches the maximum output power, include: acquiring first output voltage and second output voltage within the allowable voltage range, where when outputting the first output voltage relative to outputting the second output voltage, the instantaneous total output power of the power supply module undergoes the step change, the difference between the first output voltage and the second output voltage is greater than a threshold voltage difference range; continuously regulating the output voltage of the power supply module using a dichotomy method starting from the first output voltage and the second output voltage, and making the instantaneous total output power of the power supply module at the prior-to-regulation output voltage undergo the step change relative to the instantaneous total output power at the post-regulation output voltage, until the difference between the prior-to-regulation output voltage and the post-regulation output voltage is within the threshold voltage difference range or the instantaneous total output power of the power supply module reaches or approaches the maximum output power.

In some embodiments of the present disclosure, the first output voltage is the second target output voltage, and the second output voltage is a lower limit of the allowable voltage range.

In some embodiments of the present disclosure, the continuously regulating the output voltage of the power supply module within the allowable voltage range, and the determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range or the instantaneous total output power of the power supply module reaches or approaches the maximum output power, include: continuously regulating the output voltage of the power supply module within the allowable voltage range; after each regulation, judging whether corresponding instantaneous total output power of the power supply module is greater than the maximum output power of the power supply module; when the corresponding instantaneous total output power of the power supply module is not greater than the maximum output power of the power supply module, determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range; and when the corresponding instantaneous total output power of the power supply module is greater than the maximum output power of the power supply module, determining up-regulation or down-regulation of the output voltage of the power supply module by lowering the instantaneous total output power of the power supply module, until the instantaneous total output power of the power supply module reaches or approaches the maximum output power of the power supply module.

In a second aspect, an embodiment of the present disclosure proposes a power control apparatus, including a processor; a memory connected with the processor and configured to store a computer program; where the processor is configured to read the computer program stored in the memory to be enabled to: determine whether there is an overload device among all load devices of a power supply module, where output voltage of the power supply module is adjustable within an allowable voltage range; acquire first target output voltage of the power supply module if it is determined that there is the overload device, where the first target output voltage is within the allowable voltage range and is lower than and close to minimum working voltage of all non-working overload devices; regulate the output voltage of the power supply module to the first target output voltage.

In some embodiments of the present disclosure, the processor is further enabled to: determine whether there is the overload device among all the load devices of the power supply module, by regulating the output voltage of the power supply module within the allowable voltage range and comparing instantaneous total output power of the power supply module before regulating the output voltage with instantaneous total output power of the power supply module after regulating the output voltage.

In some embodiments of the present disclosure, the processor is further enabled to: acquire a total output electrical energy parameter of the power supply module, and obtain present first instantaneous total output power of the power supply module according to the total output electrical energy parameter, where the present first instantaneous total output power of the power supply module is a sum of power output by the power supply module to all the load devices; determine whether the power supply module is overloaded according to whether the present first instantaneous total output power of the power supply module is greater than maximum output power of the power supply module; if it is determined that the power supply module is overloaded, determine second target output voltage according to the maximum output power of the power supply module, and regulate the output voltage of the power supply module to the second target output voltage, where the second target output voltage is voltage at which actual total output power output by the power supply module to all the loaded devices does not exceed the maximum output power of the power supply module.

In some embodiments of the present disclosure, the processor is further enabled to: acquire present second instantaneous total output power of the power supply module; determine whether there is the overload device among all the load devices of the power supply module, according to whether the present second instantaneous total output power of the power supply module is lower than the maximum output power of the power supply module and a difference with the maximum output power exceeds a threshold difference.

In some embodiments of the present disclosure, the processor is further enabled to: acquire a present total output electrical energy parameter of a power output port of the power supply module, where the present total output electrical energy parameter includes present output voltage, present current, and a present phase difference; calculate and obtain the present first instantaneous total output power of the power supply module according to the present output voltage, the present current, and the present phase difference of the power supply module.

In some embodiments of the present disclosure, the processor is further enabled to: acquire the present total output electrical energy parameter of the power output port of the power supply module, where the present total output electrical energy parameter includes the present output voltage, the present current, and the present phase difference; calculate and obtain load impedance of the power supply module according to the present current or the present output voltage, as well as the present phase difference; calculate and obtain the second target output voltage according to the load impedance and the maximum output power of the power supply module; regulate the output voltage of the power supply module to the second target output voltage.

In some embodiments of the present disclosure, the processor is further enabled to: acquire the present output voltage and the present current collected from the power output port of the power supply module; calculate and obtain the present phase difference according to the present output voltage and the present current.

In a third aspect, an embodiment of the present disclosure proposes a power supply system, including an inverter or a DC to DC converting module, configured to regulate input power; a power output interface, including a main access port and multiple connection interfaces, where the main access port is connected to a power output port of the inverter or the DC to DC converting module, and the connection interfaces are configured to connect to load devices; a control chip connected to the main access port of the power output interface, and configured to collect a total output electrical energy parameter of the inverter or the DC to DC converting module; regulate the output voltage of the inverter or the DC to DC converting module according to the total output electrical energy parameter and with use of the power control method provided in the first aspect, to perform power regulation on the inverter or the DC to DC converting module.

In a fourth aspect, an embodiment of the present disclosure proposes an energy storage power supply, including: the power supply system as provided in the second aspect; and at least one battery pack, where the battery pack is used to provide power to the power supply system.

In a description of the specification, reference terms “one embodiment,” “some embodiments,” “exemplary embodiments,” “examples,” “specific examples,” or “some examples,” and the like refer to specific features, structures, materials, or features described in conjunction with the embodiments or examples included in at least one embodiment or example of the present disclosure. In this specification, illustrative expressions of the above terms may not necessarily refer to the same implementation or example. Moreover, the specific features, structures, materials, or features described can be appropriately combined in any one or more embodiments or examples.

Any process or method description in a flowchart or otherwise described herein may be understood as representing a module, fragment, or portion of codes of executable instructions containing one or more steps for implementing specific logical functions or procedures, and a scope of preferred embodiments of the present disclosure includes other implementations, which may not be in order shown or discussed. This should be understood by those skilled in the art that, to which the embodiments of the present disclosure belong, including performing functions in a fundamentally simultaneous manner or in reverse order based on the functions involved.

Logic and/or steps represented in a flowchart or otherwise described here, for example, a ordered list of executable instructions that can be considered to implement logical functions, which can be specifically implemented in any computer-readable medium for utilizing by instruction execution systems, apparatus or devices (such as computer-based systems, systems containing processing modules, or other systems that can fetch and execute instructions from the instruction execution systems, apparatus or devices), or utilizing by combining these instruction execution systems, devices or devices. In respect to this description, “computer-readable medium” may refer to the apparatus that can contain, store, communicate, propagate, or transmit programs for the utilizing by or in conjunction with the instruction execution systems, apparatus, or devices. More specific examples of the computer-readable media (a non-exhaustive list) include the following: an electrical connection component (control method) with one or more wiring, a portable computer cartridge (magnetic device), a random access memory (RAM), a read-only memory (ROM), an erasable editable read-only memory (EPROM or flash memory), a fiber optic device, and a portable optical disc read-only memory (CDROM). In addition, the computer-readable media can even be paper or other suitable media on which programs can be printed, as programs can be obtained electronically through, for example, optical scanning for the paper or other media, followed by editing, interpretation, or other appropriate processing as necessary, and then stored in a computer memory.

It should be understood that, various parts of the embodiments of the present disclosure can be implemented using hardware, software, firmware, or a combination thereof. In the above embodiments, multiple steps or methods may be implemented using the software or firmware stored in a memory and executed by an appropriate instruction execution system. For example, if it is implemented in hardware, as in another implementation, any one or a combination of the following techniques commonly known in the art can be used to implement: discrete logic circuits with logic gates for implementing logic functions on data signals, specialized integrated circuits with appropriate combination logic gates, programmable gate arrays (PGA), field programmable gate arrays (FPGA), and the like.

Ordinary technical personnel in the art can understand that all or part of the steps carried by implementing the above embodiments can be completed by instructing relevant hardware through a program, and the program can be stored in a computer-readable storage medium. The program, when executed, includes one or a combination of the steps of the method embodiments.

In addition, in various embodiments of the present disclosure, each functional unit can be integrated into a processing module, each unit can physically exist separately, or two or more units can be integrated into one module. The above integrated modules can be implemented in forms both hardware and software functional modules. If the integrated modules are implemented in the form of software functional modules and sold or used as independent products, they can also be stored in a computer-readable storage medium. The above storage media can be a read-only memory, disk, or optical disc, and the like.

Although the embodiments of the present disclosure have been shown and described above, it can be understood that the above embodiments are exemplary and cannot be understood as limitations to the present disclosure. Ordinary technical personnel in the art may make changes, modifications, substitutions, and variations to the above embodiments within the scope of the present disclosure.

What is claimed is:

1. A power control method, comprising:
determining whether there is an overload device among all load devices of a power supply module, wherein output voltage of the power supply module is adjustable within an allowable voltage range;
if it is determined that there is the overload device, acquiring first target output voltage of the power supply module, wherein the first target output voltage is within the allowable voltage range and is lower than and close to minimum working voltage of all non-working overload devices;
regulating the output voltage of the power supply module to the first target output voltage.

2. The power control method according to claim 1, wherein the determining whether there is the overload device among all the load devices of the power supply module comprises:
determining whether there is the overload device among all the load devices of the power supply module, by regulating the output voltage of the power supply module within the allowable voltage range and comparing instantaneous total output power of the power supply module before regulating the output voltage with instantaneous total output power of the power supply module after regulating the output voltage.

3. The power control method according to claim 2, before the determining whether there is the overload device among all the load devices of the power supply module, comprising:
acquiring a total output electrical energy parameter of the power supply module, and obtaining present first instantaneous total output power of the power supply module according to the total output electrical energy parameter, wherein the present first instantaneous total output power of the power supply module is a sum of power output by the power supply module to all the load devices;
determining whether the power supply module is overloaded according to whether the present first instantaneous total output power of the power supply module is greater than maximum output power of the power supply module;
if it is determined that the power supply module is overloaded, determining second target output voltage according to the maximum output power of the power supply module, and regulating the output voltage of the power supply module to the second target output voltage, wherein the second target output voltage is voltage at which actual total output power output by the power supply module to all the loaded devices does not exceed the maximum output power of the power supply module.

4. The power control method according to claim 3, wherein the determining whether there is the overload device among all the load devices of the power supply module comprises:
acquiring present second instantaneous total output power of the power supply module;
determining whether there is the overload device among all the load devices of the power supply module, according to whether the present second instantaneous total output power of the power supply module is lower than the maximum output power of the power supply module and a difference with the maximum output power exceeds a threshold difference.

5. The power control method according to claim 3, wherein the acquiring the total output electrical energy parameter of the power supply module, and the obtaining the present first instantaneous total output power of the power supply module according to the total output electrical energy parameter comprise:
acquiring a present total output electrical energy parameter of a power output port of the power supply module, wherein the present total output electrical energy parameter comprises present output voltage, present current, and a present phase difference;
calculating and obtaining the present first instantaneous total output power of the power supply module according to the present output voltage, the present current, and the present phase difference of the power supply module.

6. The power control method according to claim 3, wherein the determining the second target output voltage according to the maximum output power of the power supply module, and the regulating the output voltage of the power supply module to the second target output voltage comprise:
acquiring the present total output electrical energy parameter of the power output port of the power supply module, wherein the present total output electrical energy parameter comprises the present output voltage, the present current, and the present phase difference;
calculating and obtaining load impedance of the power supply module according to the present current or the present output voltage, as well as the present phase difference;
calculating and obtaining the second target output voltage according to the load impedance and the maximum output power of the power supply module;
regulating the output voltage of the power supply module to the second target output voltage.

7. The power control method according to claim 5, wherein the acquiring the present total output electrical energy parameter of the power output port of the power supply module comprises:
acquiring the present output voltage and the present current collected from the power output port of the power supply module;
calculating and obtaining the present phase difference according to the present output voltage and the present current.

8. The power control method according to claim 1, wherein the acquiring the first target output voltage of the power supply module comprises:
continuously regulating the output voltage of the power supply module within the allowable voltage range, and determining whether to turn up or turn down the output voltage of the power supply module in a next regulation according to whether there is a step change in instantaneous total output power of the power supply module after each regulation relative to instantaneous total output power of the power supply module prior to the regulation, until a difference between a prior-to-regulation output voltage and a post-regulation output voltage is within a threshold voltage difference range or the instantaneous total output power of the power supply module reaches or approaches the maximum output power of the power supply module, and taking a smaller one between the prior-to-regulation output voltage and the post-regulation output voltage as the first target output voltage.

9. The power control method according to claim 8, wherein the continuously regulating the output voltage of the power supply module within the allowable voltage range, and the determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range or the instantaneous total output power of the power supply module reaches or approaches the maximum output power, comprise:
acquiring first output voltage and second output voltage within the allowable voltage range, wherein when outputting the first output voltage relative to outputting the second output voltage, the instantaneous total output power of the power supply module undergoes the step change, a difference between the first output voltage and the second output voltage is greater than a threshold voltage difference range;
continuously regulating the output voltage of the power supply module using a dichotomy method starting from the first output voltage and the second output voltage, and making the instantaneous total output power of the power supply module at the prior-to-regulation output voltage undergo the step change relative to the instantaneous total output power at the post-regulation output voltage, until the difference between the prior-to-regulation output voltage and the post-regulation output voltage is within the threshold voltage difference range or the instantaneous total output power of the power supply module reaches or approaches the maximum output power.

10. The power control method according to claim 9, wherein the first output voltage is the second target output voltage, and the second output voltage is a lower limit of the allowable voltage range.

11. The power control method according to claim 8, wherein the continuously regulating the output voltage of the power supply module within the allowable voltage range, and the determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range or the instantaneous total output power of the power supply module reaches or approaches the maximum output power, comprise:
continuously regulating the output voltage of the power supply module within the allowable voltage range;
after each regulation, judging whether corresponding instantaneous total output power of the power supply module is greater than the maximum output power of the power supply module;
when the corresponding instantaneous total output power of the power supply module is not greater than the maximum output power of the power supply module, determining whether to turn up or turn down the output voltage of the power supply module in the next regulation according to whether there is the step change in the instantaneous total output power of the power supply module after each regulation relative to the instantaneous total output power of the power supply module prior to the regulation, until the difference between the prior-to-regulation output voltage and the post-regulation output voltage is within the threshold voltage difference range;
when the corresponding instantaneous total output power of the power supply module is greater than the maximum output power of the power supply module, determining up-regulation or down-regulation of the output voltage of the power supply module by lowering the instantaneous total output power of the power supply module, until the instantaneous total output power of the power supply module reaches or approaches the maximum output power of the power supply module.

12. A power control apparatus, comprising:
a processor;
a memory connected with the processor and configured to store a computer program;
wherein the processor is configured to read the computer program stored in the memory to be enabled to:
determine whether there is an overload device among all load devices of a power supply module, wherein output voltage of the power supply module is adjustable within an allowable voltage range;
acquire first target output voltage of the power supply module if it is determined that there is the overload device, wherein the first target output voltage is within the allowable voltage range and is lower than and close to minimum working voltage of all non-working overload devices;
regulate the output voltage of the power supply module to the first target output voltage.

13. The power control apparatus according to claim 12, wherein the processor is further enabled to:
determine whether there is the overload device among all the load devices of the power supply module, by regulating the output voltage of the power supply module within the allowable voltage range and comparing instantaneous total output power of the power supply module before regulating the output voltage with instantaneous total output power of the power supply module after regulating the output voltage.

14. The power control apparatus according to claim 13, wherein the processor is further enabled to:
acquire a total output electrical energy parameter of the power supply module, and obtain present first instantaneous total output power of the power supply module according to the total output electrical energy parameter, wherein the present first instantaneous total output power of the power supply module is a sum of power output by the power supply module to all the load devices;
determine whether the power supply module is overloaded according to whether the present first instantaneous total output power of the power supply module is greater than maximum output power of the power supply module;
if it is determined that the power supply module is overloaded, determine second target output voltage according to the maximum output power of the power supply module, and regulate the output voltage of the power supply module to the second target output voltage, wherein the second target output voltage is voltage at which actual total output power output by the power supply module to all the loaded devices does not exceed the maximum output power of the power supply module.

15. The power control apparatus according to claim 14, wherein the processor is further enabled to:
acquire present second instantaneous total output power of the power supply module;
determine whether there is the overload device among all the load devices of the power supply module, according to whether the present second instantaneous total output power of the power supply module is lower than the maximum output power of the power supply module and a difference with the maximum output power exceeds a threshold difference.

16. The power control apparatus according to claim 14, wherein the processor is further enabled to:
acquire a present total output electrical energy parameter of a power output port of the power supply module, wherein the present total output electrical energy parameter comprises present output voltage, present current, and a present phase difference;
calculate and obtain the present first instantaneous total output power of the power supply module according to the present output voltage, the present current, and the present phase difference of the power supply module.

17. The power control apparatus according to claim 13, wherein the processor is further enabled to:
acquire the present total output electrical energy parameter of the power output port of the power supply module, wherein the present total output electrical energy parameter comprises the present output voltage, the present current, and the present phase difference;
calculate and obtain load impedance of the power supply module according to the present current or the present output voltage, as well as the present phase difference;
calculate and obtain the second target output voltage according to the load impedance and the maximum output power of the power supply module;
regulate the output voltage of the power supply module to the second target output voltage.

18. The power control apparatus according to claim 16, wherein the processor is further enabled to:
acquire the present output voltage and the present current collected from the power output port of the power supply module;
calculate and obtain the present phase difference according to the present output voltage and the present current.

19. A power supply system, comprising:
an inverter or a DC to DC converting module, configured to regulate input power;
a power output interface, comprising a main access port and multiple connection interfaces, wherein the main access port is connected to a power output port of the inverter or the DC to DC converting module, and the connection interfaces are configured to connect to load devices;
a control chip connected to the main access port of the power output interface, and configured to collect a total output electrical energy parameter of the inverter or the DC to DC converting module;
regulate the output voltage of the inverter or the DC to DC converting module according to the total output electrical energy parameter and with use of the power control method according to claim 3, to perform power regulation on the inverter or the DC to DC converting module.

20. An energy storage power supply, comprising: the power supply system according to claim 19; and at least one battery pack, wherein the battery pack is used to provide power to the power supply system.
